(19) United States
(12) Patent Application Publication
(10) Pub. No.: US 2004/0188028 A1
(43) Pub. Date: Sep. 30, 2004

(54) Taping device

(76) Inventor: Hubert Eckart, Fulda (DE)

Correspondence Address: Striker Striker & Stenby, 103 East Neck Road, Huntington, NY, 11743, US

(21) Appl. No.: 10/483,320

(22) PCT Filed: Jul. 13, 2002
(86) PCT No.: PCT/EP02/07815

(30) Foreign Application Priority Data
Jul. 21, 2001 (DE) 201 12 040.2

(51) Int. Cl. B65C 3/12

(52) U.S. Cl. 156/446

(57) ABSTRACT

The invention relates to a device (1) for taping long objects (2) using tape (3) from a spool (4). The device (1) comprises a radial bearing ring (5) wherein a rotating inner part (6) is arranged. The radial bearing ring (5) is associated with a cut-out section (7) and the inner part (6) is associated with a radial side recess (8). On one side, the inner part (6) has a tape receiver (9) which is approximately centrically arranged and which is connected to a pendulum bearing (10) in a perpendicular manner with respect to the recess (8). The radial bearing ring (5) is selectively connected, to a handle (11) or/and to a stationary stand (12)

The invention relates to a taping device as generically defined by the preamble to claim 1.

For protection against mechanical and thermal stress, as EMC protection and/or for reducing vibration noises, cable harnesses in bicycles, passenger cars, trucks, buses, airplanes, and sometimes in machines are sheathed with tape wound helically around the cords. This tape can be adhesive or nonadhesive. This process is predominantly done today by hand without tools, or with either stationary or semistationary taping devices with an additional drive mechanism.

The object of the invention is to create a device of this same generic type that without a motor-type drive mechanism makes simple, ergonomic, fast, uniform taping of elongated objects possible and is compact and can be produced economically.

This object is attained by the definitive characteristics of claim 1. Further features of the invention will become apparent from the dependent claims.

The invention will be described in further detail in terms of two exemplary embodiments.

Shown are:

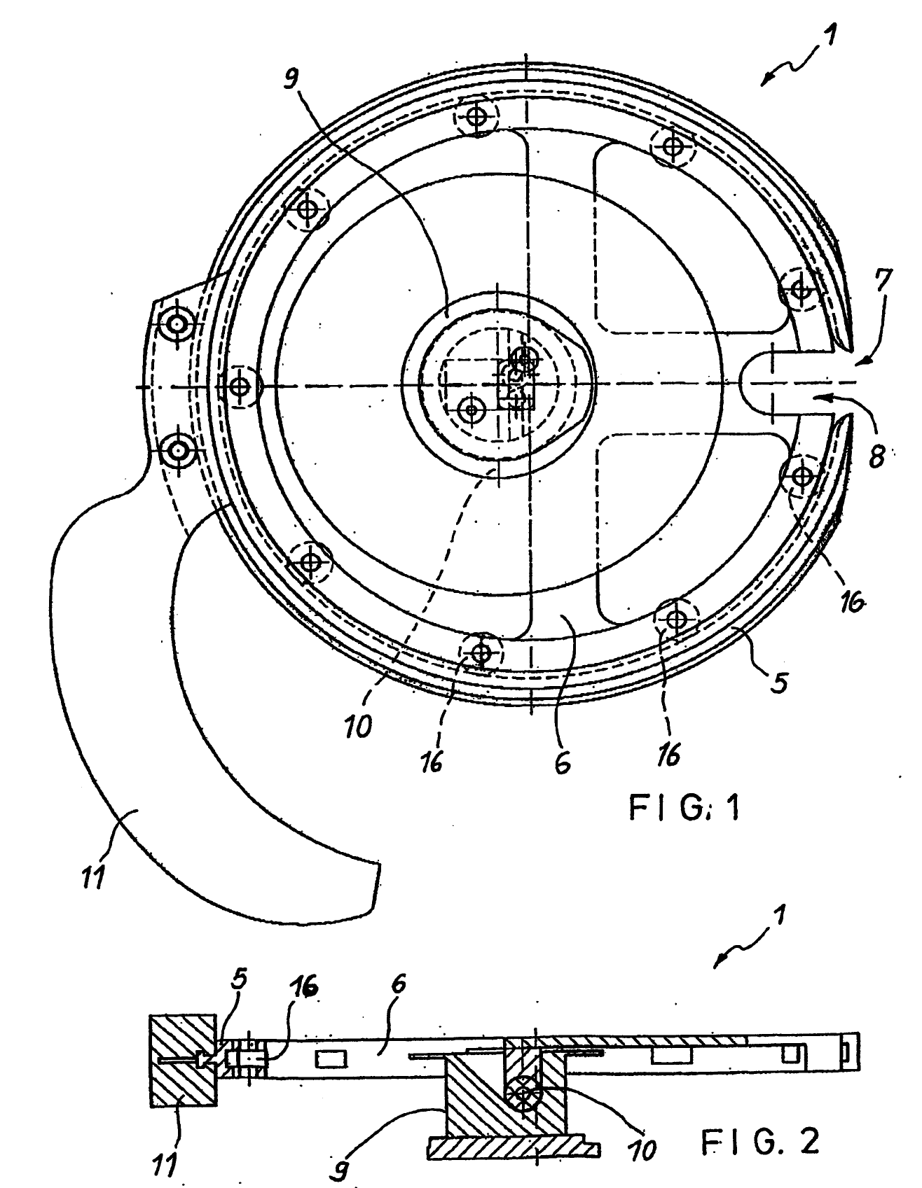

FIGS. 1-6, in various views, a first exemplary embodiment in the form of a hand-operated device; and

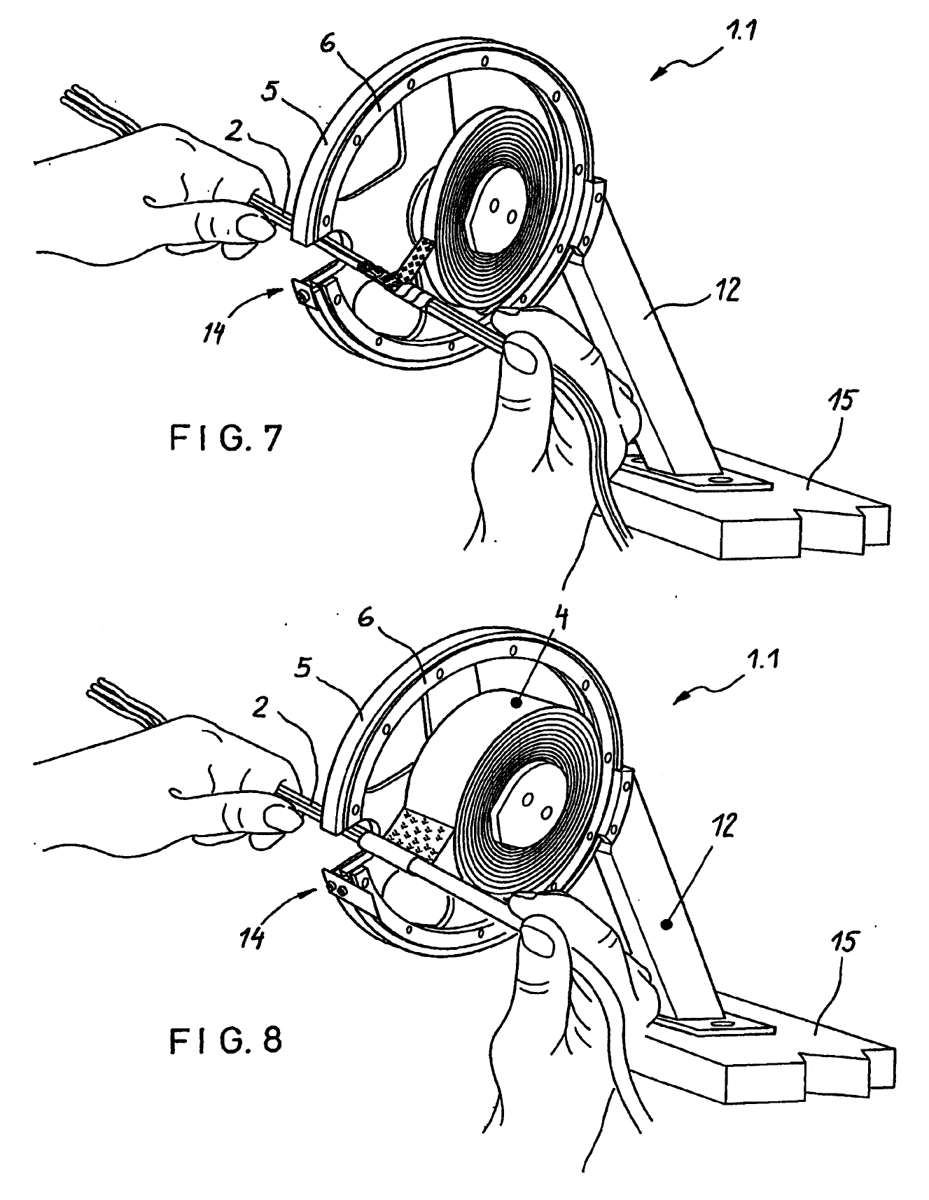

FIGS. 7 and 8, a second exemplary embodiment, in the form of a stationary device.

FIG. 1, in a side view, shows a device 1 for taping elongated objects 2 by means of a tape 3 from a spool of tape 4. The device 1 has a radial bearing ring 5, in which a rotatable inner part 6 is supported. The radial bearing ring 5 is provided with a cutout 7, and the inner part 6 is provided with a radial recess 8. The inner part 6, on one side, has an approximately centrally disposed tape holder 9, which is connected transversely to the recess 8 to a pendulum bearing 10. The inner part 6 is provided with radially disposed bearing rollers 16 at equal intervals, and as a result free rotation can be done, including via the cutout 7 of the radial bearing ring 5. The radial bearing ring 5 is connected selectively to a handle 11 and/or a stationary stand 12.

FIG. 2, in a section taken along the line II-II in FIG. 1, shows the device 1, and in this view the disposition of the pendulum bearing 10 is especially clearly shown.

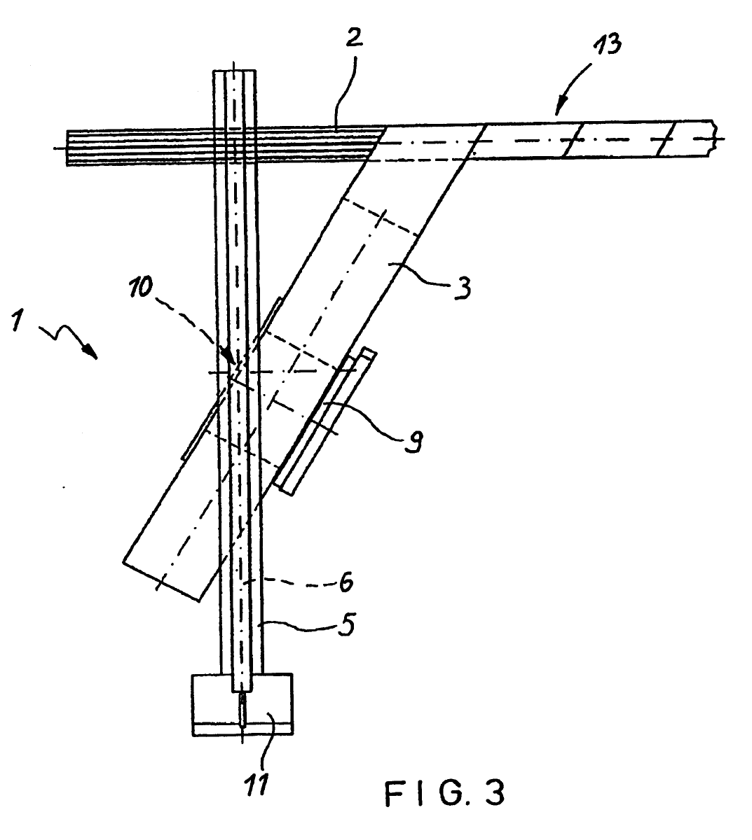

A plan view on the device 1 of FIG. 1 is shown in FIG. 3; here, the device 1 is shown in a working position of a taping operation.

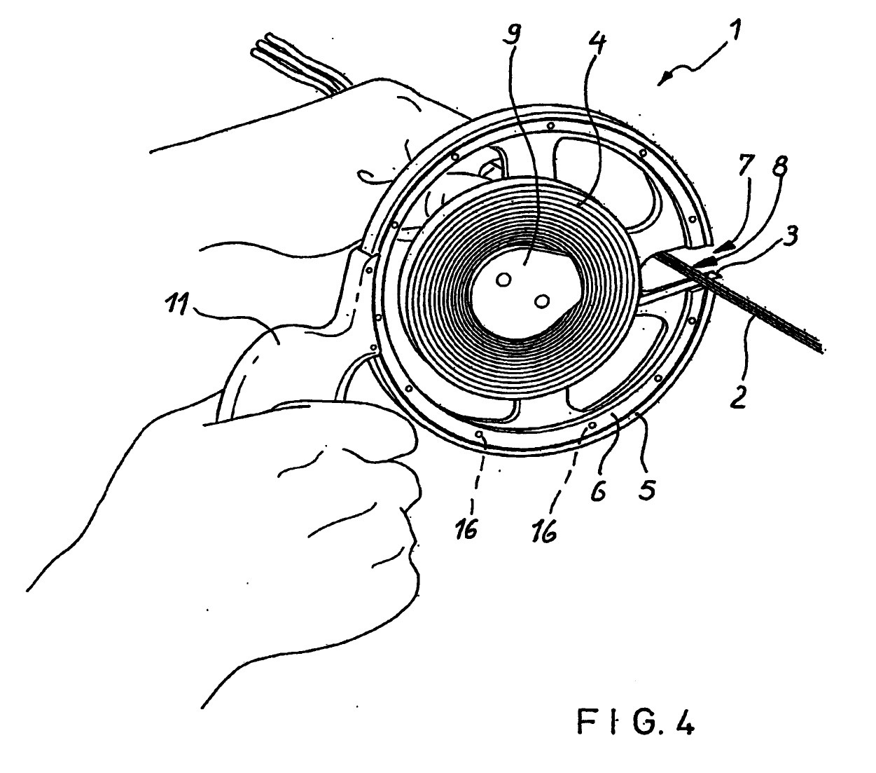

A corresponding recess 8 is made in the inner part 6, and the cable harness 2 is introduced into this recess via the cutout 7 of the radial bearing ring 5 and connected to a leading end of an adhesive side of the tape 3 (FIG. 4).

By means of the device 1, the spool of tape 4 is now passed around the elongated objects 2, or around a cable harness or other elongated product. The motion of the spool of tape 4 is attained by providing that a user guides the device 1 in a circular motion using a handle 11. The circular motion is executed without interruption outside the cable harness 2. With the handle, the circular radial bearing ring 5 secured to it is moved, in which the rotatable inner part 6 is supported in such a way as to move smoothly and is thereby set into rotation by the cable harness 2 located in the recess 8 (FIGS. 4-6).

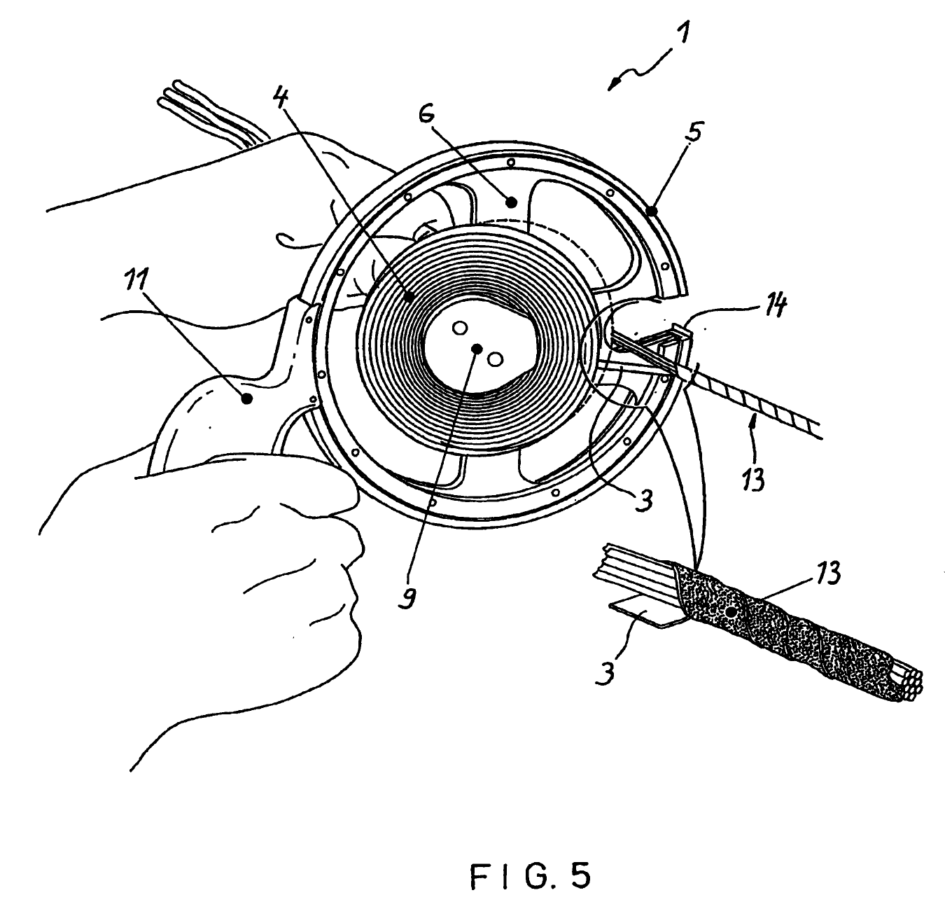

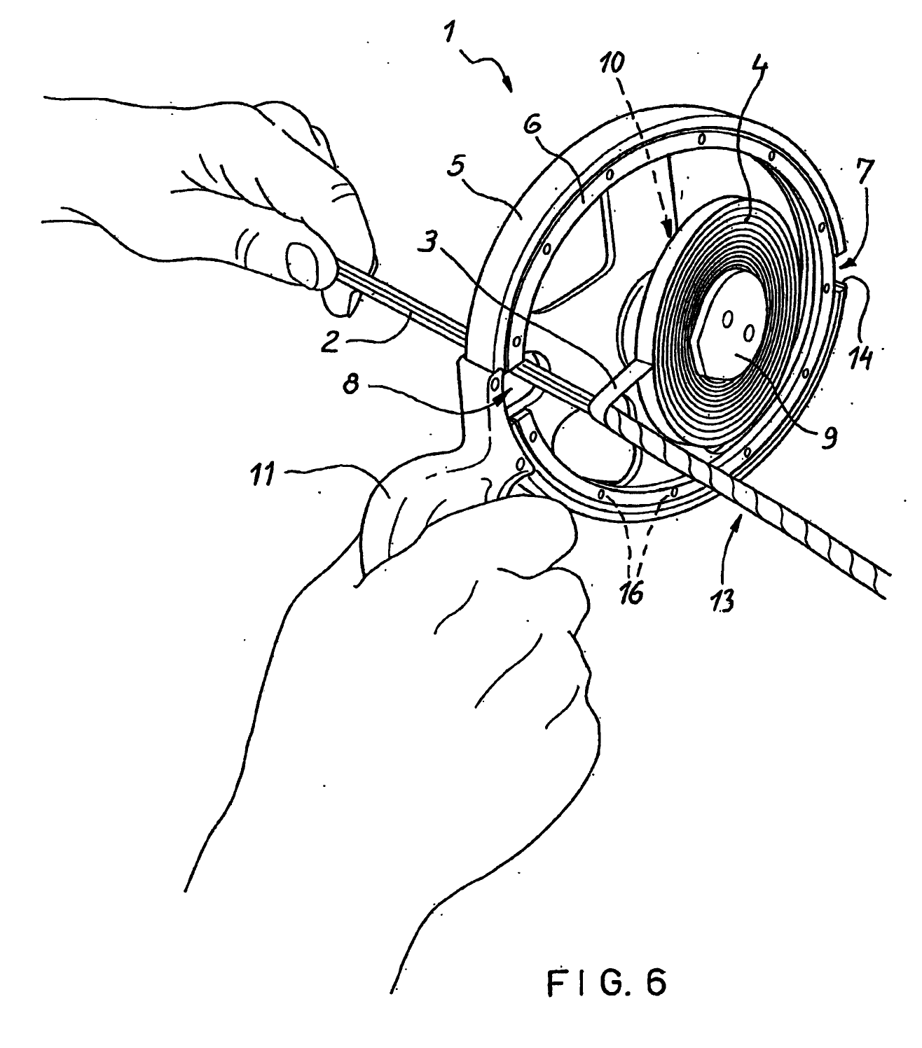

A bandage 13 is created by the fact that the inner part 6 rotates about the cable harness 2 as a result of the circular motion of the radial bearing ring 5, and thus the spool of tape 4 is passed along a circular arc about the cable harness 2. Once the tape 3 is firmly secured to the cable harness at the beginning of the bandage 13, the tape 3 peels off from the spool of tape 4 upon motion of the device 1 and simultaneously attaches to the cable harness 2. If in this motion the user also executes a longitudinal motion along the cable 2 (FIGS. 5 and 6), a bandage 13 on the cable harness 2 is created. The speed and the slope of the bandage 13 are determined by the user.

So that the tape 3 will be wound into the bandage on the cables 2 without creases, the tape 3 is placed on a tape holder 9 that is pivotably supported by means of the pendulum bearing 10. As a result of the unrolling or drawing-off tension of the tape 3, the tape 3 automatically positions itself obliquely in the slope direction and thus makes it possible to adapt the tape travel direction with the desired slope.

For cutting the tape 3 after the taping operation is ended, a tape severing device 14 is mounted on the outside of the radial bearing ring 5 (FIG. 5). By means of a suitable motion of the device 1, the tape 3 can be severed immediately next to the cable harness 2 quickly and simply at the end of the bandage 13. At the same time, the tape 3 is again in an optimal starting position (FIG. 4) in which it is ready for the beginning of the next winding operation.

Because of the modular design of the device 1, the individual components, such as the handle 11, inner part 6, tape severing device 14 and spool of tape 4, can be mounted in any required position, so that the device 1 can be used universally by both left-handed and right-handed people and for a bandage direction from right to left and vice versa.

In a second exemplary embodiment, it is provided that the device 1.1 is operated in stationary fashion, by means of a stand 12 on a table 15 or the like (FIG. 8). Then, the circular motion with the objects 2 to be wrapped should be executed by the user with a longitudinal motion (axial motion). In a special application, for instance for insulating a certain area from electrical connections, the stationary device 1.1, with a tape that is for instance 30 to 50 mm wide, can be used without an axial motion of the cable harness 2. High electrical voltage strength is achieved by means of a two- to four-layer wrapping with adhesive tape 3.

Compared to a manual bandage without tools, the device 1, 1.1 is more ergonomic, faster, and more uniform. It effectively prevents well-known occupational diseases of users and increases their output. At the same time, the surface quality of the bandage 13 is improved, and it is easier for the user to maintain the required slope or overlap.

### List of Reference Numerals

1, 1.1 Device

2 Objects

3 Tape

4 Spool of tape

5 Radial bearing ring

6 Inner part

7 Cutout

8 Recess

9 Tape holder

10 Pendulum bearing

11 Handle

12 Stand

13 Bandage

14 Tape severing device

15 Table

16 Bearing roller

1. A device for taping elongated objects by means of a tape from a spool of tape, characterized in that the device (1) has a radial bearing ring (5), in which a rotatable inner part (6) is supported; that the radial bearing ring (5) is provided with a cutout (7), and the inner part (6) is provided with a radial recess (8); that the inner part (6) on one side has an approximately centrally disposed tape holder (9), which is connected, transversely to the recess (8), with a pendulum bearing (10), and the radial bearing ring (5) is connected selectively with a handle (11) and/or a stationary stand (12).

2. The device of claim 1, characterized in that a tape severing device (14) is disposed on the cutout (7).

3. The device of claim 1, characterized in that the inner part (6) is provided radially with bearing rollers (16).
